(19) United States
(12) Patent Application Publication
(10) Pub. No.: US 2013/0123398 A1
(43) Pub. Date: May 16, 2013

(54) FLAME-PROOFED POLYMER COMPOSITIONS

(71) Applicants: Andreas Roos, Duesseldorf (DE); Gerd Bergmann, Hamburg (DE); Manuel La Rosa, Koln (DE); Oriane Cerin, La Quinte (FR); Gaëlle Fontaine, Saint Andre-Lez-Lille (FR); Sophie Duquesne, Saint Andre-Lez-Lille (FR); Serge Bourbigot, Villeneuve d'Ascq (FR)

(72) Inventors: Andreas Roos, Duesseldorf (DE); Gerd Bergmann, Hamburg (DE); Manuel La Rosa, Koln (DE); Oriane Cerin, La Quinte (FR); Gaëlle Fontaine, Saint Andre-Lez-Lille (FR); Sophie Duquesne, Saint Andre-Lez-Lille (FR); Serge Bourbigot, Villeneuve d'Ascq (FR)

(73) Assignee: LANXESS DEUTSCHLAND GMBH, Leverkusen (DE)

(21) Appl. No.: 13/517,268

(22) PCT Filed: Dec. 21, 2010
(86) PCT No.: PCT/EP10/69667

§ 371 Date: Jan. 24, 2013

(30) Foreign Application Priority Data
Dec. 21, 2009 (EP) 09306290.9

(51) Int. Cl. C08K 13/02

(52) U.S. Cl. CPC C08K 13/02
USPC 524/100; 252/609

(57) ABSTRACT

The invention relates to a flame-proofed polymer composition that can be obtained from one or more α-olefin/vinyl acetate copolymers, having a vinyl acetate content of 40 to 90 wt %, relative to the total weight of the α-olefin/vinyl acetate copolymers, and from a synergistic flame-proofing material combination, containing, as component A, a phosphinic acid salt of the formula (I), where R₁, R₂ are C₁-C₆-alkyl, preferably C₁-C₄-alkyl, linear or branched; M is calcium, aluminum, zinc ions; m is 2 or 3; and as component B, a metal hydroxide, preferably aluminum hydroxide (ATH); and, as component C, a melamine compound.

The present invention relates to a flameproofed polymer composition consisting of one or more α-olefin/vinyl acetate copolymers having a vinyl acetate content of 40 to 90% by weight, based on the total weight of the α-olefin/vinyl acetate copolymer, the use thereof and a flameproofing combination for the treatment of plastics and rubbers.

Flameproofed polymer compositions are used, for example, in cable applications (cable sheath and cable insulation) and floor coverings. Such polymer compositions should provide sufficient flameproofing complying with the statutory standards and moreover should have outstanding processing properties.

It has long been known that polymer systems can be treated with inorganic flameproofing agents, halogenated flameproofing agents, organophosphorus flameproofing agents or nitrogen-based flameproofing agents.

Metal hydroxides, in particular aluminum hydroxides (ATH) and magnesium hydroxides (MDH), which are used as flame-retardant fillers in polymers, may be mentioned as mineral flameproofing agents. Metal hydroxides are used alone or in combination with one another and optionally in combination with further flameproofing additives.

The flameproofing effect is based substantially on an endothermic decomposition of the crystals, the release of water in the form of water vapour with simultaneous dilution of the concentration of flammable gases in the vicinity of the plastic attacked and the formation of a more or less solid oxide residue. The oxide residue itself has a large internal surface area and can therefore adsorb soot particles or precursors of the soot (polycyclic aromatic hydrocarbons, PAH). The so-called ash layer has the function of mechanically stabilizing the burning polymer so that, for example, dripping of flaming particles of the polymer is reduced or completely avoided. Furthermore, the encrusted ash layer on the surface of the burning polymer acts as a sort of “protective barrier” for the polymer layers present underneath, with the result that rapid further burning can be avoided.

The use of metal hydroxides in α-olefin/vinyl acetate copolymers has proved particularly useful.

However, the large amounts of metal hydroxides added to plastic mixtures in order to ensure sufficient flameproofing of the plastic are disadvantageous. The physical properties (mechanical and electrical characteristics) of the plastic are adversely affected thereby.

Furthermore, salts of phosphinic acids (phosphinates) have proved to be effective flame-retardant additives for polymer systems. Calcium and aluminum phosphinates have been described as being particularly effective in polyesters or polyamides and adversely affect the material properties of the polymer masses to a lesser extent than, for example, alkali metal salts.

Synergistic combinations of phosphinates with certain nitrogen-containing compounds, which in many polymers act more effectively as flameproofing agents than the phosphinates alone have also been found. For example, melamine and melamine compounds are known to be effective synergistic agents, such as, for example, melamine cyanurates and melamine phosphate.

It is therefore an object of the present invention to provide a polymer composition in which the filler system (comprising flame-retardant substances) is varied in such a way that the flameproofing effect at least remains the same or is improved but the mechanical properties of the polymer are improved and especially the hardness is reduced.

For achieving this object, the present invention proposes a flameproofed polymer composition of the type mentioned at the outset, which consists of one or more α-olefin/vinyl acetate copolymers having a vinyl acetate content of 40 to 90% by weight, based on the total weight of the α-olefin/vinyl acetate copolymer, and of a synergistic flameproofing combination containing, as component A, a phosphinic acid salt of the formula (1)

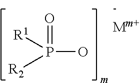

in which
R1, R2 denotes C₁-C₆-alkyl, preferably C₁-C₄-alkyl, linear or branched;
M denotes calcium, aluminum or zinc ions;
m denotes 2 or 3,
as component B, a metal hydroxide, preferably aluminum hydroxide (ATH) and
as component C, a melamine compound.

Here, component A is also designated as phosphinates.

Surprisingly, it was found that, by means of the combination of metal hydroxides, phosphinates and melamine compounds, the flameproofing properties (in particular the LOI and the UL-94 rating) are significantly improved and at the same time the flexibility of the materials is increased or lower hardnesses are achievable.

Various parameters are used for assessing the flameproofing.

One indicative value for assessing the flameproofing and in particular the ignitability is the limiting oxygen index (LOI) according to ISO 4589. It describes the minimum concentration of oxygen in an oxygen mixture which is just capable of supporting the combustion of a vertically oriented test specimen. At lower oxygen concentration, the flame is extinguished. High LOI values therefore denote high flameproofing or low ignitability.

Further characteristics relevant for the flameproofing can be determined using the cone calorimeter, such as, for example:
the “peak heat release rate” in KW/m² (PHRR); this is the maximum power output, per unit area, which was measured in the cone calorimeter during combustion of the sample. The lower the PHRR, the better is the flameproofing of the sample.
the “time to ignition” (TTI); this is the time when the sample begins to burn due to the heat emission in the cone calorimeter. The higher the TTI value, the better is the flameproofing of the sample.

A further method for assessing and classifying the flammability of plastics is the UL 94 specification. The UL 94 classification is carried out with 3.2 mm thick samples. According to UL 94-V standard, the classifications are not classified (NC), V2 (better), Vi (better still), VO (highest classification).

Preferably, component A is an aluminum phosphinate.

The melamine compound is preferably melamine phosphate, melamine borate and/or melamine cyanurate.

The total amount of synergistic flameproofing combination of the polymer composition according to the invention is preferably between 90 and 310 phr, particularly preferably between 100 and 190 phr.

The polymer composition according to the invention preferably has 70 to 190 phr of component B, 10 to 60 phr of component A and 10 to 60 phr of component C.

It has also been found that a certain composition of the flameproofing combination according to the invention particularly significantly increases the synergistic effect.

Particularly preferably, the polymer composition according to the invention has 80 to 160 phr of ATH, 10 to 30 phr of aluminum phosphinate and 10 to 20 phr of melamine phosphate or melamine borate.

Here, “phr’ means parts per hundred rubber.

The α-olefin/vinyl acetate copolymers used are distinguished by high vinyl acetate contents of ≧40% by weight, based on the total weight of the α-olefin/vinyl acetate copolymers. Preferably, the vinyl acetate content of the α-olefin/vinyl acetate copolymers used according to the invention is 50% by weight to 80% by weight, based on the total weight of the α-olefin/vinyl acetate copolymers.

The α-olefin/vinyl acetate copolymer used may have one or more further comonomer units (e.g. terpolymers), for example based on vinyl esters and/or (meth)acrylates, in addition to the monomer units based on α-olefin and vinyl acetate. The further comonomer units are—if further comonomer units are present in the α-olefin/vinyl acetate copolymer—present in a proportion of up to 10% by weight, based on the total weight of the α-olefin/vinyl acetate copolymer, the proportion of the monomer units based on the α-olefin decreasing correspondingly. Thus, for example, α-olefin/vinyl acetate copolymers which are composed of 40% by weight to 90% by weight of vinyl acetate, 10% by weight to 60% by weight of α-olefin and 0 to 10% by weight of at least one further comonomer can be used, the total amount of vinyl acetate, α-olefin and the further comonomer being 100% by weight.

In the α-olefin/vinyl acetate copolymers used, all known α-olefin can be employed as α-olefin. The α-olefin is preferably selected from ethene, propene, butene, in particular n-butene and isobutene, pentene, hexene, in particular 1-hexene, heptene and octene, in particular 1-octene.

It is also possible to use higher homologues of said α-olefins as α-olefins in the α-olefin/vinyl acetate copolymer. The α-olefins may furthermore carry substituents, in particular C₁-C₅-alkyl radicals. Preferably, however, the α-olefins carry no further substituents. Furthermore, it is possible to use mixtures of two or more different α-olefins in the α-olefin/vinyl acetate copolymer. However, it is preferable not to use mixtures of different α-olefins. Preferred α-olefins are ethene and propene, ethene being particularly preferably used as α-olefin in the α-olefin vinyl acetate copolymer.

Thus, the preferably used α-olefin/vinyl acetate copolymer is an ethylene/vinyl acetate copolymer.

Particularly preferred ethylene/vinyl acetate copolymers have a vinyl acetate content of 50% by weight to 80% by weight.

Usually, the preferably used ethylene/vinyl acetate copolymers having high vinyl acetate contents are designated as EVM copolymers, the “M” in the designation indicating the saturated backbone of the methylene main chain of the EVM.

The α-olefin/vinyl acetate copolymers used, preferably ethylene/vinyl acetate copolymers, have in general MFI values (g/10 mm), measured according to ISO 1133 at 190° C. and a load of 21.1 N, of 1 to 40, preferably 1 to 35.

The Mooney viscosities according to DIN 53 523 ML 1+4 at 100° C. are in general 3 to 80, preferably 20 to 65, Mooney units.

The number average molecular weight (Mw), determined by means of GPC, is in general from 5,000 g/mol to 800,000 g/mol, preferably 100,000 g/mol to 400,000 g/mol.

Ethylene/vinyl acetate copolymers which are commercially obtainable, for example, under the trade name Levapren® or Levamelt® from Lanxess Deutschland GmbH are particularly preferably used in the flameproofed polymer composition according to the invention.

The polymer composition according to the invention has an LOI of at least 35% and at the same time a maximum hardness of 85 Shore A.

The flameproofed polymer composition according to the invention can be used in plastics and rubbers, thermoplastic elastomers or thermoplastic vulcanizates.

A further invention is the use of the flameproofed polymer composition according to the invention for the production of cables, plastic moulding materials, resilient moulding materials, floor coverings (particularly in public means of transport or buildings), electrical, coated conductors and adhesives or for the modification of thermoplastics, thermoplastic elastomers and thermoplastic vulcanizates.

It is therefore conceivable also to use the flameproofed polymer composition according to the invention in blends. For example, the following polymers are suitable here: HNBR, EPDM, EVA, HDPE, LDPE, polyamide and/or copolyester.

For example, cable sheaths for certain areas must be oil-resistant since oil incorporated by steeping impairs the function at the latest in the event of a fire and additionally increases the fume density. Furthermore, the cables must remain flexible even at temperatures below minus 40° C. and must exhibit good electrical insulation properties so that they operate reliably even in the case of small wall thicknesses.

It is also conceivable to use maleic anhydride-grafled (MAHg) EVM/EVA in the blend. The vinyl acetate content for the MAHg EVM/EVA is 18 to 90% by weight, based on the total weight of the α-olefin/vinyl acetate copolymer, preferably 32 to 80% by weight and very particularly preferably 40 to 70% by weight. The content of MAHg EVM/EVA is 5 to 50 phr, preferably 10 to 40 phr and particularly preferably 10 to 20 phr.

The flameproofing combination for the preparation of a flameproofed polymer composition comprising one or more α-olefin/vinyl acetate copolymers having a vinyl acetate content of 40 to 90% by weight, based on the total weight of the α-olefin/vinyl acetate copolymer, is also a further invention, said combination containing an aluminium phosphinate as component A, a metal hydroxide, preferably aluminium hydroxide (ATH), as component B and a melamine compound as component C.

A vinyl acetate content of 50-80% by weight, based on the total weight of the α-olefin/vinyl acetate copolymer, is preferred.

It has been found that this combination has an outstanding flameproofing effect which is particularly suitable for said α-olefin/vinyl acetate copolymer with respect to simultaneously low hardness.

Furthermore, the flameproofed polymer composition according to the invention has relatively low concentrations of toxic fumes according to EN ISO 5659-2. In particular, it has for example no HCl gas since the α-olefin/vinyl acetate copolymer is halogen-free.

The cables, cable sheaths, plastic moulding materials, resilient moulding materials, floor coverings and electrical, coated conductors produced therefrom remain flexible even at temperatures below −40° C.

The flameproofing combination according to the invention preferably has 70 to 190 phr of component B, 0 to 60 phr of component A and 10 to 60 phr of component C.

Preferably, the flameproofing combination according to the invention comprises 80 to 160 phr of ATH, 10 to 30 p1w of aluminium phosphinate and 10 to 20 phr of melamine phosphate or melamine borate.

The flameproofing combination according to the invention is suitable for the treatment of plastics and rubbers, thermoplastic elastomers or thermoplastics vulcanizates.

It is preferably used in ethylene/vinyl acetate copolymers which are commercially obtainable, for example, under the trade name Levapren® or Levamelt® from Lanxess Deutschland GmbH, or in blends with HNBR, EPDM, EVA, HDPE, LDPE, polyamides and/or copolyesters.

The flameproofing combination according to the invention is halogen-free and, owing to the low viscosity and good compatibility with polar fillers, can take up large amounts of inorganic flameproofing agents, such as aluminium hydroxide. When compounds containing the flameproofing combination according to the invention burn, only fumes of low density form. HCl gas, for example, which forms on combustion of halogen-containing compounds, cannot be given off at all by pure ethylene/vinyl acetate copolymers, owing to their chemical composition.

These advantages are displayed in particular in railway traffic or in buildings; there, people should be able to leave the areas affected by fire without external help; this also certainly includes the escape routes remaining visible for a long time.

Preferably, the total amount of synergistic flameproofing combination is between 90 and 310 phr, particularly preferably between 100 and 190 phr, for the abovementioned uses.

The invention will be explained in more detail below with reference to examples:

Substances used:
EXOLIT OP 1230 (from Clariant): phosphinic acid salt
MELAGARD MP (from Italmatch Chemicals): melamine phosphate
MELAGARD MB (from Italmatch Chemicals): melamine borate
MELAGARD MC (from Italmatch Chemicals): melamine cyanurate
Perkadox 14-40 B-PD (from AKZO NOBEL): crosslinking agent
Rhenofit TAUS (from Rheinchemie): coagent
CORAX N 550/30 (from Evonik Industries): carbon black
Vulkasil N (from Lanxess Deutschland GmbH): silica (pale filler)
Diplast TM 8-10/ST (from Polynt): plasticizer (TOTM)
Edenol 888 (from Emery Oleochemicals GmbH): plasticizer (DOS)
Aflux 18 (GE 1855) (from Rheinchemie): processing auxiliary
Edenor C18 98-100 (from Emery Oleochemicals GmbH): processing auxiliary
Vulkanox HS/LG (from Lanxess Deutschland GmbH): antiageing agent (TMQ)

Disflamoll TOF (from Lanxess Deutschland GmbH): flameproofing plasticizer

TABLE 1
Levapren, phosphinic acid salt and melamine compound (without ATH)

| Formulation: | M1 | M2 | M3 | M4 | M5 | M6 |
|---|---|---|---|---|---|---|
| LEVAPREN 600 HV | 100 | 100 | | | | |
| EXOLIT OP 1230 | | 55 | 37 | 41 | 37 | 37 |
| MELAGARD MP | | | 18 | 14 | | |
| MELAGARD MB | | | | | 18 | |
| MELAGARD MC | | | | | | 18 |
| PERKADOX 14-40 B-PD | 6 | 6 | 6 | 6 | 6 | 6 |
| RHENOFIT TAC/S | 1 | 1 | 1 | 1 | 1 | 1 |
| Total phr | 107 | 162 | 62 | 62 | 62 | 62 |
| Hardness [Shore A] | 46 | 63 | 63 | 62 | 66 | 6.1 |
| Elongation at break [%] | 223 | 329 | 294 | 270 | 308 | 283 |
| Tensile strength [MPa] | 3.3 | 9.9 | 6.5 | 5.8 | 9.1 | 6.1 |
| LOI [%] | 19 | 40 | 57 | 55 | 63 | 32 |
| UL-94 rating | NC | NC | V0 | V1 | NC | NC |

TABLE 2
Levapren, phosphinic acid salt and melamine compound (complete formulation
without ATH)

| Formulation: | N1 | N2 | N3 | N4 | N5 | N6 | N7 | N8 |
|---|---|---|---|---|---|---|---|---|
| LEVAPREN 600 HV | 100 | 100 | 100 | 100 | 100 | 100 | 100 | 100 |
| CORAX N 550/30 | 2 | 2 | 2 | 2 | 2 | 2 | 2 | 2 |
| VULKASIL N | 30 | 30 | 30 | 30 | 30 | 30 | 30 | 30 |
| DIPLAST TM 8-10/ST | 10 | 10 | 10 | 10 | 10 | 10 | 10 | 10 |
| EDENOL 888 | 10 | 10 | 10 | 10 | 10 | 10 | 10 | 10 |
| AFLUX 18 (GE 1855) | 2 | 2 | 2 | 2 | 2 | 2 | 2 | 2 |
| EDENOR C 18 98-100 | 2 | 2 | 2 | 2 | 2 | 2 | 2 | 2 |
| VULKANOX HS/LG | 2 | 2 | 2 | 2 | 2 | 2 | 2 | 2 |
| PERKADOX 14-40 B-PD | 6 | 6 | 6 | 6 | 6 | 6 | 6 | 6 |
| RHENOFIT TAC/S | 1 | 1 | 1 | 1 | 1 | 1 | 1 | 1 |
| EXOLIT OP 1230 | | 60 | | | | | | 40 |
| EXOLIT OP 950 | | | 60 | | | | | |
| EXOLIT OP 1311 | | | | 60 | | | | |
| MELAGARD MB | | | | | 60 | | | |
| MELAGARD MC | | | | | | 60 | | |
| MELAGARD MP | | | | | | | 60 | 20 |
| Total phr | 165 | 225 | 225 | 225 | 225 | 225 | 166 | 205 |
| Hardness [Shore A] | 25 | 44 | 44 | 46 | 53 | 54 | 47 | 46 |
| Elongation at break [%] | 342 | 614 | 629 | 512 | 572 | 610 | 692 | 678 |
| Tensile strength [MPa] | | 7.6 | 4.1 | | 6.7 | 10.4 | 7.8 | 7.7 |
| LOI [%] | 22 | 37 | 25 | 36 | 27 | 28 | 27 | 38 |
| UL-94 rating | NC | NC | NC | V1 | NC | NC | NC | V0 |

Both tables show different combinations of phosphinic acid salts and melamine compounds without ATH. Table 1 shows formulation examples without further additives, Ml serving as a reference formulation. Table 2 shows formulation examples with further additives, N1 serving as a reference formulation. The adverse effect of further constituents of a mixture (e.g.: plasticizer, processing auxiliary, etc.) on the flameproofing properties is evident here (cf. LOI and UL-94 rating in Tab. 1 with Tab. 2).

The following tables show flameproofed polymer compositions according to the invention.

TABLE 3
Flameproofed polymer compositions according to the invention

| | | | |
|---|---|---|---|
| LEVAPREN 600 HV | 100 | 100 | 100 |
| CORAX N 550/30 | 2 | 2 | 2 |
| APYRAL 120 E | 120 | 84 | 84 |
| VULKASIL N | 30 | 30 | 30 |
| ZINC BORATE | 10 | 10 | 10 |
| DISFLAMOLL TOF | 20 | 20 | 20 |
| AFLUX 18 (GE 1855) | 2 | 2 | 2 |
| EDENOR C 18 98-100 | 2 | 2 | 2 |
| VULKANOX HS/LG | 2 | 2 | 2 |
| PERKADOX 14-40 B-PD | 6 | 6 | 6 |
| RHENOFIT TAC/S | 1 | 1 | 1 |
| EXOLIT OP 1230 | | 27 | 24 |
| MELAGARD MB | | 9 | |
| MELAGARD MP | | | 12 |
| Total phr | 295 | 295 | 295 |
| Hardness [Shore A] | 68 | 60 | 58 |
| Elongation at break [%] | 490 | 530 | 531 |
| Tensile strength [MPa] | 7.3 | 6.7 | 6.8 |
| LOI [%] | 36 | 44 | 43 |
| TTI [s] | 49 | 59 | 56 |
| PHRR [kW/m²] | 136 | 127 | 115 |
| UL-94 rating | NC | V0 | V0 |

Table 3 shows improved flameproofing in the case of the flameproofed polymer composition according to the invention comprising ATH, phosphinic acid salt and melamine compound, illustrated by the increase of LOI, TTI and UL-94 rating and the reduction of the PHRR. It is even possible to reduce the hardness in comparison with the reference formulation. The mechanical values are comparable.

TABLE 4
Demonstration of the flameproofing effect of the
polymer composition according to the
invention compared with a polymer composition with ATH.

| Formulation: | P1 | P2 |
|---|---|---|
| LEVAPREN 600 HV | 100 | 100 |
| CORAX N 550/30 | 2 | 2 |
| APYRAL 120 E | 180 | 160 |
| VULKASIL N | 30 | 30 |
| DISFLAMOLL TOF | 20 | 20 |
| AFLUX 18 (GE 1855) | 2 | 2 |
| EDENOR C 18 98-100 | 2 | 2 |
| VULKANOX HS/LG | 2 | 2 |
| PERKADOX 14-40 B-PD | 6 | 6 |
| RHENOFIT TAC/S | 1 | 1 |
| EXOLIT OP 1230 | | 20 |
| MELAGARD MP | | 10 |
| Total phr | 345 | 355 |
| Hardness [Shore A] | 73 | 78 |
| Elongation at break [%] | 527 | 531 |
| Tensile strength [MPa] | 6.8 | 6.2 |
| LOI [%] | 46 | 55 |
| TTI [s] | 161 | 201 |
| PHRR [kW/m²] | 80 | 68 |
| UL-94 rating | V0 | V0 |

Table 4 demonstrates the surprising effect of the flameproofed polymer composition according to the invention. Both the ratio and the synergistic combination of ATH, phosphinic acid salt and melamine compound lead to a significant increase in the flameproofing.

The above-described effects of the flameproofed polymer composition according to the invention are shown by means of graphs:

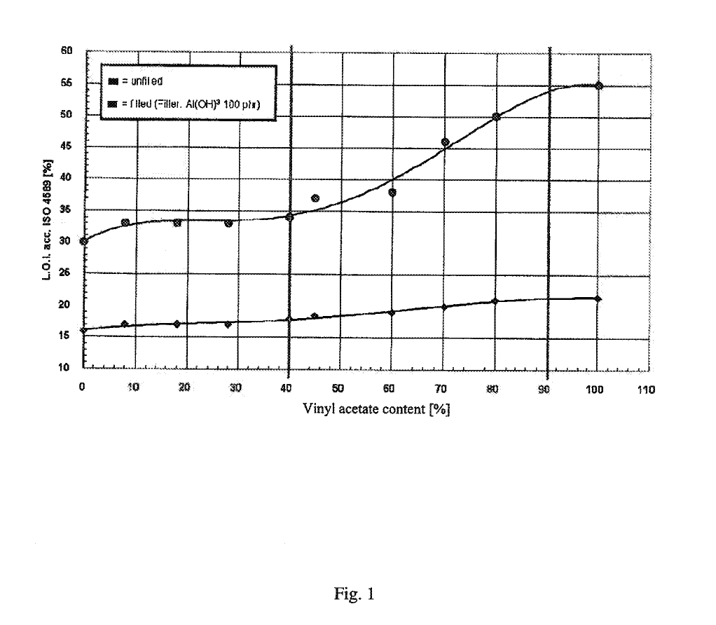

FIG. 1: Graph of LOI values of α-olefin/vinyl acetate copolymers with and without ATH

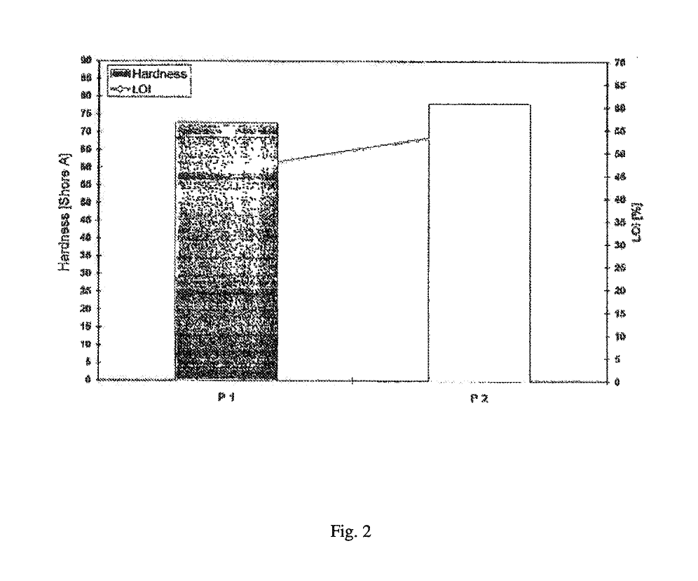

FIG. 2: Graph relating to Tab. 4, hardness and LOI

FIG. 1 shows an increase in the LOI value with the use of ATH, in particular as soon as the vinyl acetate content (VA) of the α-olefin/vinyl acetate copolymer exceeds 40% by weight. In the case of an increase from 0 to 40% by weight of VA, the LOI increases by about 15% (LOI: 30%=>LOI:35%). In the case of an increase from 40 to 80% by weight of VA, the LOI increases by about 40% (LOI: 35%=>LOI: 50%).

FIG. 2 shows an improved LOI value of the flameproofed polymer composition according to the invention, in contrast to that from the prior art with ATH.

What is claimed is:

1. Flameproofed polymer composition obtainable
from one or more α-olefin/vinyl acetate copolymers having a vinyl acetate content of 40 to 90% by weight, based on the total weight of the α-olefin/vinyl acetate copolymer and
from a synergistic flameproofing combination containing, as component A, a phosphinic acid salt of the formula (I) 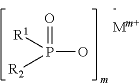
in which
R′, R2 denotes C1-C6-alkyl, preferably C1-C4-alkyl, linear or branched;
M denotes calcium, aluminium or zinc ions;
m denotes 2 or 3,
as component B, a metal hydroxide, preferably aluminium hydroxide (ATH), and
as component C, a melamine compound.

2. Flameproofed polymer composition according to claim 1, characterized in that component A is an aluminium phosphinate.

3. Flameproofed polymer composition according to claim 1, characterized in that the melamine compound is melamine phosphate, melamine borate and/or melamine cyanurate.

4. Flameproofed polymer composition according to any of the abovementioned claims, characterized in that the total amount of synergistic flameproofing combinations is between 90 and 310 phr, preferably 100 to 190 phr.

5. Flameproofed polymer composition according to claim 4, characterized in that it has 70 to 190 phr of component B, 10 to 60 phr of component A and 10 to 60 phr of component C.

6. Flameproofed polymer composition according to claim 5, characterized in that it has 80 to 160 phr of ATH, 10 to 30 phr of aluminium phosphinate and 10 to 20 phr of melamine phosphate.

7. Flameproofed polymer composition according to claim 6, characterized in that it has an LOI of at least 35% and at the same time a hardness of not more than 85 Shore A.

8. Use of the flameproofed polymer composition according to any of the preceding claims in the production of cables, plastic moulding materials, electrical coated conductors and adhesives and floor coverings.

9. Flameproofing combination for the preparation of a flameproofed polymer composition comprising one or more α-olefin/vinyl acetate copolymers having a vinyl acetate content of 40 to 90% by weight, based on the total weight of the α-olefin/vinyl acetate copolymer, characterized in that it contains a phosphinate, preferably an aluminium phosphinate, as component A, a metal hydroxide, preferably aluminium hydroxide (ATH), as component B and a melamine compound, preferably melamine phosphate, as component C.

10. Flameproofing combination for the preparation of flameproofed polymer compositions according to claim 9, characterized in that it has 70 to 190 phr of component B, 10 to 60 phr of component A and 10 to 60 phr of component C.

11. Flameproofing combination for the preparation of flameproofed polymer compositions according to claim 10, characterized in that it has 80 to 160 phr of ATH, 10 to 30 phr of aluminium phosphinate and 10 to 20 phr of melamine phosphate.

12. Use of a flameproofing combination according to any of claims 9 to 11 for the treatment of plastics and rubbers, thermoplastic elastomers or thermoplastic vulcanizates.
